(19) United States
(12) Patent Application Publication
(10) Pub. No.: US 2026/0346182 A1
(43) Pub. Date: Nov. 5, 2026

(54) ADSORBENT STRUCTURES AND METHOD AND SYSTEM FOR DESIGNING ADSORBENT STRUCTURES

(71) Applicant: Commonwealth Scientific and Industrial Research Organisation, Acton, ACT (AU)

(72) Inventors: Gerald PEREIRA, Acton (AU); Philip KILBY, Acton (AU); Gerard HOWARD, Acton (AU); Paulus LAHUR, Acton (AU)

(21) Appl. No.: 19/130,913

(22) PCT Filed: Nov. 15, 2023
(86) PCT No.: PCT/AU2023/051158

§ 371 Date: May 16, 2025

(30) Foreign Application Priority Data
Nov. 18, 2022 (AU) 2022903490
Mar. 21, 2023 (AU) 2023900789

(51) Int. Cl. B01D 53/04; B33Y 50/00; G06F 30/17; G06F 30/28; G06F 111/06

(52) U.S. Cl. CPC B01D 53/0407; G06F 30/17; G06F 30/28; B01D 2257/504; B33Y 50/00; G06F 2111/06

(57) ABSTRACT

A method of manufacturing a robotic manipulator including determining desired manipulator properties including a manipulator shape and manipulator jamming properties; using the manipulator jamming properties and a packing computational model to determine a packing element configuration, the packing computational model defining relationships between manipulator jamming properties and different packing element configurations; controlling an additive printing machine based on the packing element configuration and manipulator shape to manufacture the robot manipulator. The robot manipulator includes a flexible outer skin defining a chamber; a connector attached to the outer skin and connected to a fluid pump to allow fluid to be added to or removed from the chamber; filling elements disposed in the chamber according to the packing element configuration.

### CROSS-REFERENCE TO RELATED APPLICATIONS

The present application claims priority from Australian Provisional Patent Application No 2022903490 filed on 18 Nov. 2022 and Australian Provisional Patent Application No. 2023900789 filed on 21 Mar. 2023, the contents of which are incorporated herein by reference in their entirety.

### TECHNICAL FIELD

The present invention relates to the field of computer-assisted design of complex geometries. In particular, the present invention relates to adsorbent structures and the computer-assisted design of adsorbent structures.

### BACKGROUND

Direct air capture (DAC) of carbon dioxide (CO₂) from air is a method of reducing CO₂ concentrations in a body of air. Direct air capture (DAC) comprises the adsorption of CO₂ from air onto an adsorption surface.

In some implementations, a DAC process involves blowing air through an adsorbent structure to enable the adsorbent structure to adsorb CO₂ from the air blown through the adsorbent structure

There are numerous unique geometries for adsorbent structures and the geometries of high performing adsorbent structures can be intricate and complex. It is desirable to be able to identify at least one geometry for an adsorbent structure that will perform well for an intended specific application. Furthermore, it is desirable to determine a preferred geometry for an adsorbent structure via a design methodology that ameliorates the high cost associated with the manufacture of several designs and re-designs, and experimental testing of each candidate design before identifying the most suitable design for a given application.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

### SUMMARY

The present inventors have undertaken significant research and development into alternative methods for determining improved adsorbent structure designs and have advantageously identified a computational workflow that can determine a well performing adsorbent structure design for certain applications. It has been found that there are two (independent) components to the design process. Firstly, an underlying (numerical) physical model which can allow a user to obtain useful quantitative measures which can be then used to assess the suitability of a particular computer design. Secondly, an Artificial Intelligence (AI) algorithm that can take into consideration the measures from the numerical model and then based on these predict enhanced mixer geometries which improve the performance a mixer device for a given application.

A method of determining an adsorbent structure design comprises:
determining, one or more design parameters, the one or more design parameters parameterising a production rule;
determining, by a design algorithm executing on a first processing device, a candidate adsorbent structure design based on the one or more design parameters by executing the production rule,
wherein determining the candidate adsorbent structure design comprises generating a replication of a baffle template, as defined by the production rule parameterised by the one or more design parameters, to generate multiple repetitions of the baffle template protruding into the fluid flow;
applying a computational fluid dynamics algorithm, executing on a second processing device, to the candidate adsorbent structure design to determine a fitness value;
iteratively optimising the design parameters by repeatedly (i) determining the candidate adsorbent structure design and (ii) determining the fitness value to improve the fitness value; and
in response to the fitness value satisfying a fitness threshold, selecting the candidate adsorbent structure design to be manufactured.

In some embodiments, the production rule is represented by a text string.

In some embodiments, the text string comprises a selection of commands from a command set.

In some embodiments, the command set comprises commands that define movements of a writing head to define geometric properties of the candidate adsorbent structure design.

In some embodiments, the command set comprises one or more commands to replicate a template shape component to generate multiple repetitions of the template shape component to generate a plurality of shape components.

In some embodiments, the one or more commands to replicate the template shape are recursive commands.

In some embodiments, the method further comprises generating a design description of the candidate adsorbent structure design; and controlling an additive printing machine, in accordance with the design description, to manufacture an adsorbent structure.

In some embodiments, the design parameters comprise manufacturing constraints.

In some embodiments, the fitness value comprises one or more of an indication of a level of adsorption, a bulk mixing level, or a pressure drop caused by the candidate adsorbent structure design.

In some embodiments, the method further comprises:
in response to the fitness value not satisfying the fitness threshold:
determining, by the design algorithm, a second candidate adsorbent structure designs based on the candidate adsorbent structure design;
applying the computational fluid dynamics algorithm, to the second candidate adsorbent structure designs to determine a second fitness value; and
in response to the second fitness value satisfying a second fitness threshold, selecting the second candidate adsorbent structure designs to be manufactured.

In some embodiments, the method further comprises determining the second fitness threshold based on the fitness value.

In some embodiments, the design algorithm comprises an evolutionary design algorithm.

In some embodiments, determining a second candidate adsorbent structure design comprises determining a second candidate adsorbent structure design based on the candidate adsorbent structure design and the fitness value.

In some embodiments, the evolutionary design algorithm comprises a shape generator algorithm and a grid generator algorithm.

In some embodiments, determining a candidate adsorbent structure design comprises:
determining a set of genes defining the candidate adsorbent structure design;
determining, using the shape generator algorithm, a candidate adsorbent structure shape based on the set of genes; and
determining, using the grid generator algorithm, a candidate adsorbent structure volume based on the candidate adsorbent structure shape.

In some embodiments, determining the set of genes comprises determining the set of genes based on the design parameters.

In some embodiments, determining a candidate adsorbent structure design comprises determining a plurality of candidate adsorbent structure designs.

In some embodiments, applying a computational fluid dynamics algorithm comprises for each candidate adsorbent structure design of the plurality of candidate adsorbent structure designs, apply a computational fluid dynamics algorithm, executing on the processing device, to the candidate adsorbent structure design to determine a respective fitness value.

In some embodiments, the method further comprises selecting one of the plurality of adsorbent structure designs, based on the plurality of respective fitness values.

In some embodiments, the computational fluid dynamics algorithm comprises a numerical module configured to calculate the velocity field of fluid flowing through the candidate adsorbent structure design.

In some embodiments, iteratively optimising is for objectives of surface area and fluid flow.

In some embodiments, the computational fluid dynamics algorithm applies a Lattice Boltzmann method.

In some embodiments, the method comprises generating a design description comprising a stereolithographic file.

In some embodiments, the first processing device comprises the second processing device.

A system comprises one or more processors; and memory comprising computer executable instructions, which when executed by the one or more processors, cause the system to perform the above method.

A machine-readable storage medium stores instructions which, when executed by one or more processors, cause the one or more processors to perform the above method.

An adsorbent is structure made from methods described above.

A catalytic adsorbent structure comprises the above adsorbent structure and a catalytic coating.

An elongated integral scaffold is produced according to the above methods and comprises a plurality of geometrically shaped components, wherein each component is configured and arranged in multiple orientations along the longitudinal axis of the scaffold to form one or more sets of components having a polygonal cross-section and defining a plurality of passages configured for flow of one or more fluids through the passages while contacting a surface of each component during flow and reaction thereof through the structure.

In some embodiments, each component is supported by an outer wall of the adsorbent structure.

In some embodiments, each set of components forms a continuous network of passages arranged in multiple orientations relative to one another.

In some embodiments, each set of components are polytope structures repeated periodically along the longitudinal axis of the elongated support member.

In some embodiments, each set of components are arranged in multiple orientations relative to one another.

In some embodiments, each set of components form a ripple structure that extends along the longitudinal axis of the scaffold.

In some embodiments, each set of components is a pair of rectangular sheets that are repeated at one or more angles along the longitudinal axis of the scaffold.

In some embodiments, each set of components comprises multiple parallel, longitudinally aligned rectangular components and the rectangular components of a first set are interleaved with rectangular components of a second set.

In some embodiments, each set of components comprises at least four polygonal baffles arranged in multiple orientations within a given set of components and repeated along the longitudinal axis of the scaffold.

In some embodiments, the scaffold is coated with a CO₂ adsorbent and is configured to adsorb CO₂ from a fluid stream.

In some embodiments, the fluid stream is air.

The various features and embodiments of the present invention, referred to in individual sections above apply, as appropriate, to other sections, mutatis mutandis. Consequently, features specified in one section may be combined with features specified in other sections as appropriate

Further embodiments of the above aspects are described below.

### BRIEF DESCRIPTION OF DRAWINGS

Preferred embodiments of the present disclosure will now be further described and illustrated, by way of example only, with reference to the accompanying drawings in which:

FIG. 1 illustrates an adsorbent structure comprising a contactor and a plurality of tubules, according to an embodiment;

FIG. 2 illustrates the architecture of a design system performing an iterative workflow, according to an embodiment;

FIG. 3 illustrates a flowchart of a method performed by the grid generator module, according to an embodiment;

FIG. 4 is a flowchart illustrating a method performed by the design system, according to an embodiment;

FIG. 5 illustrates an example generated candidate adsorbent structure designs, referred to as the “bristle” L-System. For clarity, walls are not shown.

FIG. 6 illustrates another example candidate adsorbent structure designs, referred to as the “Hexrain” L-System.

FIG. 7 illustrates another example candidate adsorbent structure designs, referred to as the X-System.

FIG. 8 illustrates another example candidate adsorbent structure designs, referred to as the Ripple System.

FIG. 9 illustrates the progress of solution values through genetic algorithm generations.

FIG. 10 illustrates the Pareto results of the Bristle system.

FIGS. 11a and 11b show two of the more successful designs of the Bristle system.

FIG. 12 illustrates the Pareto results of the hexrain system.

FIGS. 13a-13d show some of the geometries from the hexrain family that lie on the Pareto front.

FIG. 14 illustrates non-dominated solutions using the X system.

### DETAILED DESCRIPTION

The present disclosure describes the following various non-limiting embodiments, which relate to investigations undertaken to design and manufacture adsorbent structures having an improved range of design complexity by implementing a design process based on numerical modelling, to understand the underlying flow physics, and artificial intelligence to guide users to new, hitherto unknown, solid geometries. It will be appreciated that the solid geometries may also include fenestrated geometries or porous geometries. It has surprisingly been found that with this advance in production of the design of adsorbent structures, there is provided the option to explore unique and more complex adsorbent structure designs to determine designs which improve performance over existing adsorbent structure designs.

Further details and embodiments of the adsorbent structures are described below.

### GENERAL TERMS

In the following description, reference is made to the accompanying drawings which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, and processes, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Herein the term “about” encompasses a 10% tolerance in any value or values connected to the term.

### SPECIFIC TERMS

“Element” refers to an individual unit that can be used together with one or more other components in forming a continuous flow reactor system. Examples of an element include an “insert” or “module” or “baffle” as described herein.

“Single pass reactor” refers to a reactor used in a process or system where the fluidic components pass through the reactor on a single occasion and are not recycled back through the reactor from which they have already passed through.

“Aspect ratio” means the ratio of length to diameter (L/d) of a single unit or element.

### Adsorbent Structures

It has been found that an adsorbent structure, at least according to some examples as described herein, in a particular application, can act as an adsorption site on which a particular substance of a gas is adsorbed and then permanently extracted from the gas phase. In other words, the adsorbent structure is located within a fluid flow and the elements of the adsorbent structure consist of baffles that protrude into the fluid flow. This way, the structure deviates the fluid flow to aid in adsorption. It will be appreciated that the efficiency of the adsorbent structure is dependent on how well the structure (i.e. scaffold) can adsorb dissolved substances in the gas phase. Alternatively, efficiency can be dependent on a catalysis reaction when the adsorbent structure is coated with a catalyst. Whilst the present disclosure describes specific applications as a proof-of-concept, it will be understood that the adsorbent structures described herein may also serve for a variety of applications.

Since adsorption occurs at the substrate surface, it is desirable to maximise the surface area of the substrate; however, maximising the surface area of the substrate may have two consequences on the flow of gas through the adsorbent structure. Firstly, if the substrate area is increased, the solid's volume may also be increased, which results in a greater obstruction to gas flow within the reactor. This can lead to, at worst, blockage of the tube or to a lesser extent curtail the flow. Secondly, the gas should ideally be maximally dispersed to all regions of the adsorbent structure to result in a uniform adsorption onto the entire substrate. Accordingly, for this example application, it is desirable to arrive at a design for an adsorbent structure that optimises the two parameters of maximising surface area of the substrate and maximising dispersion of the gas. For other applications, there may be different or additional parameters to consider (such as pressure gradient, shear rate, etc.).

The present disclosure is directed to providing improvements in adsorbent structure designs for adsorption of substances from a gas. The present disclosure covers various research and development directed to identifying and better understanding the designs of adsorbent structures for a variety of industries such as industrial applications requiring adsorption of substances from gasses, liquids or combinations thereof. It will be appreciated that projections may comprise a bio-inspired evolved architecture. In other words, the design of the adsorbent structure may be a blend of architecture and biomimetics/bioinspiration.

Traditionally, design improvement of adsorbent structures has been led by a human designer's intuition, knowledge, experience, which may be supported by some numerical modelling. However, to test whether a new adsorbent structure design performs well for a given application, the new adsorbent structure may need to be manufactured, tested experimentally, and further re-design required until an optimal design is achieved for a particular application. One or more disadvantages associated with this traditional approach includes time and cost associated with manufacturing, experimentally testing each candidate adsorbent structure design to identify a desirable design, and further re-design and manufacture of the adsorbent structures. The time and cost often limits the extent of the design space that can be explored to identify a preferable adsorbent structure design.

Provided herein is an iterative computational workflow that is configured to determine a design for an adsorbent structure that will perform well for an intended flow application.

The inventors have found that the adsorbent structures described herein designed, using an iterative computational workflow configured to determine an effective design for an adsorbent structure, can provide enhanced performance for a specific flow application. The computational workflow comprises an evolutionary design (ED) algorithm configured to generate candidate adsorbent structure designs, and a computational fluid dynamics (CFD) algorithm, configured to numerically evaluate the performance of the candidate adsorbent structure designs for a specific application. The evolutionary design algorithm and the CFD algorithm operate iteratively to arrive at one or more adsorbent structure designs that are expected to improve performance for the intended application.

### Monoliths

As used herein, a monolith refers to a structure configured to adsorb substances from a gas or liquid. In some embodiments, a monolith comprises a substantially elongated structure (e.g. a cylinder) through which the gas or liquid flows along a liquid or fluid flow path. The internal structure of the monolith comprises multiple baffles that protrude into the fluid flow and thereby provide a large surface area upon which to adsorb the target substance. In some embodiments, the monolith comprises an outer structure, referred to as a contactor. In some embodiments, the monolith includes a plurality of passageways for the gas or liquid to flow through the monolith. The passageways may comprise tubules. The passageways may comprises a plurality of individual tubules positioned within an outer structure (contactor) of the monolith. The tubules may be integrally formed with, or attached to, one or more other tubules. The tubules may be integrally formed with, or attached to, the contactor.

Provided herein is an iterative computational workflow that is configured to determine a design for an adsorbent structure which may be utilised as a monolith or part thereof.

As described further below, the adsorbent structure designed by the computational workflow may comprise a single tubule, which is configured to be replicated en masse as part of a CO₂ capture system. Alternatively, or additionally, the adsorbent structures designed by the computational workflow may comprise a plurality of homogenous, or heterogeneous tubules, which are configured to function together as part of a CO₂ capture system. The tubules may be implemented en masse in parallel or in series as part of the CO₂ capture system. Alternatively, or additionally, the adsorbent structures designed by the computational workflow may comprise one or more tubules in association with one or more contactors.

### Adsorbent Structure Designs

There are numerous unique geometries for adsorbent structures and the geometries of high performing adsorbent structures can be intricate and complex.

Known adsorbent structures comprise a cylindrical contactor with a simple internal geometrical structure for the internal volume of the contactor. In one example, the internal geometrical structure for the adsorbent structure comprises a flat MOFs coated metal sheet, rolled it up into a spiral and inserted it into a cylindrical contactor. The metal surface of the spiral sheet is parallel to the airflow. That means streamlines of air flow do not get deflected by the contactor and generally follow along a straight path into and out of the contactor. This lack of deflection of airflow during passage through the adsorbent structure can mean that air is not coming into contact with the adsorbent surfaces of the adsorbent structure to facilitate sufficient adsorption of the target substance (e.g. CO₂).

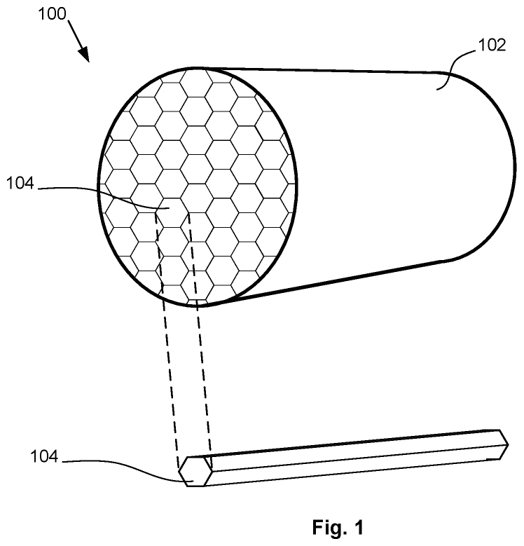

FIG. 1—Example adsorbent structure

FIG. 1 illustrates an example design of an adsorbent structure 100. Adsorbent structure 100 comprises a tubular shaped contactor 102, which, in turn comprises a plurality of small tubules (e.g. 104) which run the length of the contactor 102. In this example, the tubules are coated with the MOF to enhance CO₂ adsorption.

In some examples, so that the tubules fill as much as possible of the interior contactor cross-section, the tubules have a square or hexagonal cross-section. In the example illustrated in FIG. 1, the small tubules have a hexagonal cross section; however, in other examples, the tubules may have a cross section of another shape or shapes, such as circular, square, octagonal. A contractor may comprise a plurality of tubules having a plurality of different cross sections. The tubular cross section may change along the length of the tubule.

In one example, the contactor 102 is approximately half a meter in diameter, and the tubules (e.g. 104) are approximately 6 mm diameter. In one example, tubules are located adjacent to each other to fit snugly within the contactor 102.

### Improved Adsorbent Structure Designs

Tubules may comprise an inner structure (i.e. an adsorbent substructure) which may be inserted into the tubule, integrally formed with the tubule or affixed to the tubule. The absorbent substructure may act to deflect the flow of air through the tubule to add in the contact of the air upon the adsorbent surface of the tubule, thus aiding in the adsorption of the target substance to the surface of the tubule. The adsorbent structures designed by the computational workflow may comprise an inner structure (i.e. an adsorbent substructure) configured to be located inside a tubule.

It is desirable to determine a design of an adsorbent structure, including the design of any inner structures, which will increase CO₂ adsorption. The primary characteristics to be optimised are the transport of fluid (air) to the solid (metal) surfaces for a given pressure gradient. In other words, the geometry of the inner structure cannot obstruct the flow of air too greatly as this may result in a pressure head which exceeds the pressure threshold of the mechanical pump which supplies air to the adsorbent structure. In addition, it is often desirable that the fluid (air) is transported to all parts of the adsorbent structure, rather than focusing on specific areas. In term of fluid dynamics, this requires the streamlines (or trajectories of air particles) to be as chaotic as possible, i.e., taking a meandering path through the adsorbent structure and making contact with the surface of the adsorbent structure. Each contact gives an opportunity for the CO₂ to be adsorbed (captured), and hence is very important. If the air can flow through without touching the sides, then little CO₂ will be extracted.

Accordingly, a first objective of the design process for an adsorbent substructure is transport to substructure. This objective in essence measures how much of the flow touches the substructure. A second objective is bulk mixing. Bulk mixing indicates how well the air is agitated during the flow through the vessel. The more the air is agitated, the more opportunity will arise to interact with the surface.

The design of the interior of the contactor is a macroscopic problem, rather than a problem of microscopic adsorption. To design optimal adsorbent structures, including the geometry of the contactor, the tubules and any tubule inner structures, a computer-based design process may be performed.

The present disclosure provides methods that can be used to supplement the human design input to predict new geometries with computer-based methods which can naturally evolve to an optimal geometry.

In some embodiments, the methods use an Evolutionary Design Algorithm (EA) [Eiben03] which are population-based, iterative optimisers. EAs are particularly suited for optimisation because they can efficiently explore vast regions of a complex design space and generate a diverse range of useful solutions. Coupled to the EA is a Computational Dynamics Fluid (CFD) solver whose purpose is to evaluate the merit of the proposed solution, i.e., generate a figure of merit (a quantitative measure for the feature to be optimised, e.g., adsorption) for each design modelled. The figures of merit will be optimised by iteration. Changes to the shape of the adsorbent structure will be controlled by EAs that respond to not just changes to the figures of merit, but also to how fast the figures of merit are changing.

A significant impediment restricting the optimal design of contactors has been the limitations provided by traditional manufacturing methods. Ideal designs could not be made using traditional techniques. Additive manufacturing has removed almost all these impediments. To do this, the output from the combinatory workflow comprises Stereo-Lithographic (STL) files which are transferred to the 3D Print laboratory for metal printing.

The approach in this disclosure is based on combining Computational Fluid Dynamics (CFD) with Evolutionary Design (ED) to determine preferred designs for absorbent structures. The CFD is based on the Lattice Boltzmann (LB) method which solves Boltzmann transport equation, and this provides fitness measures for the ED to process and predict new, improved geometries. It is important to note that the CFD can be quite computational consuming so that the coupled workflow is implemented and run on a dedicated High-Performance Computing (HPC) facility over several weeks to months. The following sections give an overview of the computational workflow and details on specific parts of it, including the CFD and ED components.

### Design Workflow

Provided herein is an iterative computational workflow that is configured to determine a design for an adsorbent structure that will perform well for an intended flow application.

The computational workflow comprises an evolutionary design (ED) algorithm configured to generate candidate adsorbent structure designs, and a computational fluid dynamics (CFD) algorithm, configured to numerically evaluate the performance of the candidate adsorbent structure designs for a specific application. The evolutionary design algorithm and the CFD algorithm operate iteratively to arrive at one or more well performing adsorbent structure designs.

With similarities to natural evolution, the computational workflow is based on iterations over multiple, successive generations with each generation comprising of multiple children. In one embodiment, one or more initial designs (parent designs) are input to the ED module. Over many generations, the fitness values improve and once a termination condition is met, the computational workflow outputs the best performing adsorbent structure design(s). The termination condition may be one of:
exceeded a maximum number of iterations,
the improvement between successive iterations is below a threshold (i.e. the improvement in the fitness value diminishes until a plateau is reached),
exceeded a predefined fitness value.

As described herein, the design process may be based on Evolutionary Design (ED), which are population-based, iterative optimisers. It will be appreciated that EDs are particularly suited for optimisation because they can efficiently explore vast regions of a complex design space and generate a diverse range of useful solutions. The inputs to these algorithms are fitness objectives which, when evaluated, yield quantitative measures for the features which need to be optimised for each design modelled. The fitness values may be optimised by iteration. Changes to the adsorbent structure shape may be controlled by EDs that respond to not just changes to the fitness values, but also to how fast the fitness values are changing. It will be appreciated that the ED as described herein may create a population of individuals with geometries that can perform better as adsorbent structures than their previous generation. It has two major parts: (i) Evolution Algorithm (EA), which involves the genotype and performance index of the individuals in a generation as input and produces the genotype of the individuals in the next generation; and (ii) Shape Generator (SG), where the genotype from EA can be expressed into a geometry as its phenotype. The performance of a particular geometry in a certain environment can then be evaluated with computational fluid dynamics (CFD), i.e. this may provide a performance index. In combination, EA and SG “design” geometries can provide increasingly better adsorbent structures, one generation at a time. The “genes” communicated between EA and SG take the form of a set of real number between (and including) zero and one. The size of the set varies with the type of geometry.

The operation of the coupled workflow may be computationally expensive. Accordingly, in one embodiment, the workflow is parallelized to run on multiple central processing units (CPUs), concurrently. In one embodiment, the workflow is implemented on High-Performance Computer (HPC) clusters (NCI Gadi and Pawsey) so as to maximize the number of different computer experiments that can be run and also the number of different families of geometries that can be tested.

Computational fluid dynamics (CFD) software can be used in the design to obtain various enhanced configurations of the adsorbent structure, which will be determined by the desired applications.

The geometry may be chosen and optimised to enhance various characteristics of the adsorbent structure, such as the specific surface area, volume displacement ratio, line-of-sight accessibility for coating, strength and stability for high flow rates, suitability for fabrication using additive manufacturing, or to achieve a high degree of chaotic advection, turbulent mixing, or heat transfer. These characteristics, as well as any other characteristics of interest, may be weighted based on their relative importance to a particular application, and the design optimisation process can be directed towards enhancing the characteristics which are given more weight.

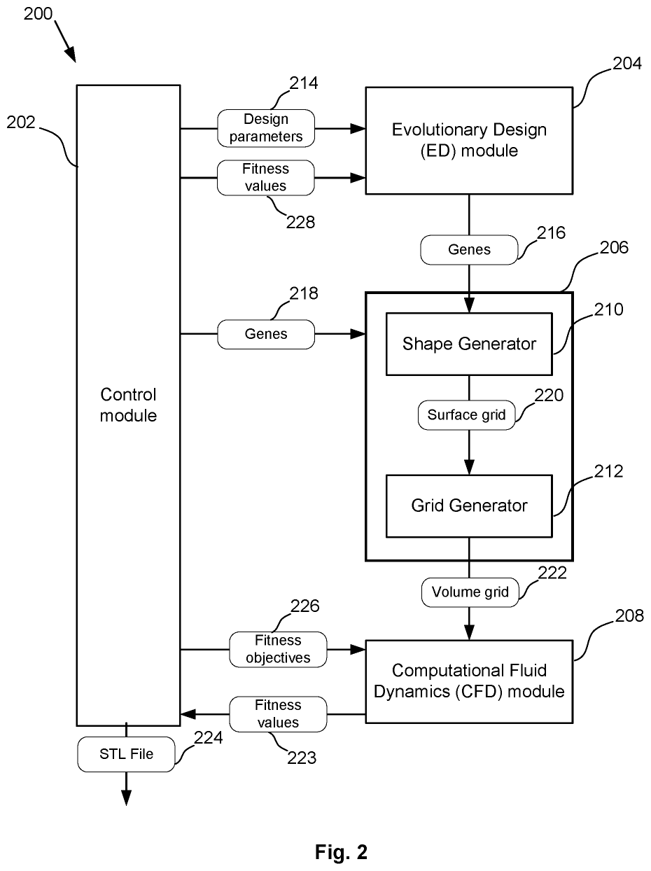

### FIG. 2—Software Architecture

FIG. 2 illustrates the architecture of a design system 200 embodying the computation workflow, according to an embodiment. The design system 200 may be embodied by one or more software modules. The software modules may be executed on one or more processors (also referred to as processing devices, computational devices, or computers).

The design system 200 comprises a plurality of sub-modules that work in conjunction to determine a preferred design for an adsorbent structure. In particular, the design system 200 comprises a control module 202, an evolutionary design module 204, a generator module 206 and a computational fluid dynamics module 208.

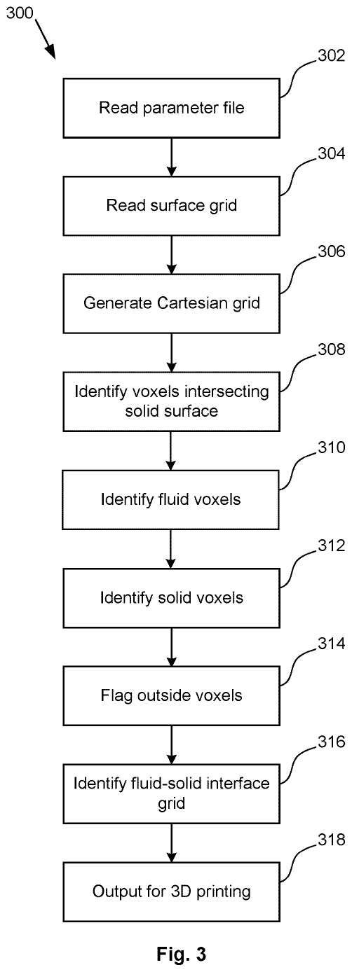

The control module 202 is configured to control the operation of the evolutionary design module 204, the generator module 206 and the computational fluid dynamics module 208 during execution of these modules. In one embodiment, the control module 202 performs method 300 as illustrated in FIG. 3.

### Evolutionary Design Module

The ED module 204 is configured to operate in iterations, generating a new generation of candidate adsorbent structure designs in each iteration. A generation of adsorbent structure designs may comprise one or more adsorbent structure designs.

In each iteration, the ED module 204 is configured to apply an evolutionary design algorithm to an existing set of genes, which define one or more first candidate adsorbent structure designs, to determine evolved set of genes, which define a new generation (e.g. a second set) of candidate adsorbent structure designs. The ED module applies the determines an evolved set of genes that the ED module predicts are likely to define adsorbent structures that perform better than the previous generation of candidate adsorbent structure designs (or, on the first iteration, better than the initial parent designs).

For some situations, evolutionary design algorithms are particularly suited for determining an optimised design because the evolutionary design algorithms can efficiently explore vast regions of a complex design space and generate a diverse range of useful solutions. In one embodiment, the ED module 204 is based on Evolutionary Design (ED) (Eiben and Smith, 2003; Cheney et al, 2013), which are population-based, iterative optimisers. In one embodiment, the ED algorithm, performed by the ED module, comprises a machine-learning algorithm. In one embodiment, the ED algorithm, performed by the ED module, comprises artificial intelligence.

The inputs to the ED module 202 are the design parameters 214 and the fitness values 228 of one or more previous candidate adsorbent structure designs, wherein the fitness values are determined by the CFD module 208.

In one embodiment, in an initial iteration of the ED module 202, the inputs to the ED module are the design parameters 214, designs of one or more initial parent adsorbent structures, and fitness values associated with the one or more initial parent adsorbent structures. In one embodiment, the fitness values are provided by the CFD module, as detailed below.

In one embodiment, the ED module 204 determines one or more first candidate adsorbent structure designs based on the one or more design parameters, then the ED module determines one or more second candidate adsorbent structure designs based on the one or more first candidate adsorbent structure designs. The ED module may determine the one or more second candidate adsorbent structure designs based on the one or more first candidate adsorbent structure designs and fitness values associated with the one or more first candidate adsorbent structure designs.

In one embodiment, the ED module 204, performs cross-overs and gene mutations between the genes of a previous generation of candidate designs to determine gene sets for a new generation of candidate designs.

The ED module 204 may perform a process of “crossover” to combine characteristics of two or more “parent” designs. The ED module 204 may use mutation of genes, and even local search, to diversify and improve the quality of the resulting “offspring” designs. The ED module may then apply a selection process to reduce the population of offspring designs to a manageable set of candidate designs which may be tested by the CFD module 208.

In one embodiment, the ED module 204 applies the Nondominated Sorting Genetic Algorithm II (NSGAII) as described in [Deb 2000]. The ED module may configure the algorithm with default parameter values.

### Design Parameters

The control module 202 provides design parameters 214 to the ED module 204. In one embodiment, the design parameters comprise information which can guide the ED module's development of adsorbent structure designs. In one embodiment, the design parameters comprise information which can be used by the ED module to constrain the adsorbent structure designs produced by the ED module.

The design parameters may comprise the physical dimensions of the adsorbent structure to be designed, such as a length and a diameter. The physical dimensions may define spatial boundaries beyond which the features of the adsorbent structure design should not protrude. The design parameters may further comprise a 3D print resolution (e.g., grain size), or other physical parameters related to the manufacture of the adsorbent structure.

In one embodiment, the design parameters comprise a base geometry which defines the basic geometry of the adsorbent structures to be designed by the ED module 204.

In one embodiment, the base geometry does not comprise a central support post but instead, the support is provided by the side walls which surround each tubule. That is, each component is connected or affixed to the side walls and as result, the side walls provide support to keep the components in place.

### Design Guidance

In one embodiment, the design parameters 214 comprise design guidance parameters. An unguided evolutionary design algorithm may face fundamental challenges in generating an adsorbent structure design, because there is an infinite number of possible designs for an adsorbent structure and also there are constraints imposed by the 3D Printing process which need to be adhered to. Accordingly, it may be desirable to reduce the possible design space and make it more easy to explore.

The design space may be reduced by providing the evolutionary design module 204 with some design guidance. Design guidance may be determined through consideration of existing adsorbent structure designs that perform well for intended application. Additionally, design guidance may be determined through consideration of nature, where living organisms have adapted to specific environment by developing certain geometric features.

Design guidance may also be determined through an understanding of fluid dynamics. This understanding of fluid dynamics can be expressed as guidance to the ED module 204, in the form of basic adsorbent structure shapes that can be composed, by the ED module 204, into much more complex shapes. In some embodiments, the ED module 204 can determine a plurality of variations to these basic shapes, to be performance tested by the CFD module 208.

### Parent Designs

In some embodiments, the design parameters comprise one or more initial parent designs. The ED module 204 can be configured to determine candidate adsorbent structure designs based on the one or more initial parent designs. The one or more initial parent designs may comprise a reference adsorbent structure design, an existing well-performing adsorbent structure design, or an adsorbent structure design as chosen or determined by the human operator. Preferably, a well-performing adsorbent structure design is a design that achieves or exceeds at least one of the fitness objective for a particular application.

### Fitness Objectives

In one embodiment, the design parameters 214 comprise one or more fitness objectives. The design parameters may further comprise one or more desired fitness values associated with a fitness objective. In one embodiment, each fitness objective is associated with a desired fitness value.

The fitness objectives represent performance attributes of the adsorbent structure. Fitness objectives may differ depending upon the intended application for the adsorbent structure being designed by the ED module 202. In one embodiment, the fitness objectives comprise a ‘transport to substrate’ fitness objective. ‘Transport to substrate’ is a measure of the percentage of tracer particles achieving impact with the substrate of the adsorbent structure. For one application, the desired fitness value for the ‘transport to substrate’ fitness objective may be 60% or greater.

Fitness objectives may be evaluated by the CFD module 208. The ED module 204 may be configured to evolve an adsorbent structure design that provides improved, or optimised, performance with regard to at least one fitness objective during the evolutionary design process. This may be referred to as designing to optimise a fitness objective. The ED module 204 may be configured to design to optimise more than one fitness objective concurrently. The ED module 204 may be configured to find a design that provides an acceptable performance balance between two or more fitness objectives, with regard to desired fitness values.

The CFD module 208 also receives an indication of the fitness objectives 226 from the control module 202. The CFD module evaluates how each candidate design performs with regard to each fitness objective, and provides one or more fitness values 223, in relation to each fitness objective for each candidate design evaluated by the CFD module, to the control module.

From the control module 202, the ED module 204 receives the fitness values 228, wherein the fitness values provide an indication of how each candidate design performs with regard to each fitness objective 226. The ED module 204 may compare a fitness value for a fitness objective with a desired fitness value associated with that fitness objective.

Example fitness objective categories include ‘bulk mixing’, which provides an indication of the extent of mixing of the fluids traversing the adsorbent structure; ‘transport-to-substrate’ which provides an indication of adsorption on the surface of the adsorbent structure; and a measure of cavitation events, which provides an indication of the formation micro-bubbles/bubbles. Fitness objectives may include a measure of the surface area of a substrate of the adsorbent structure, a substrate adsorption or absorption rate; a cumulative adsorption rate; an electric field of the adsorbent structure; a pressure drop or gradient caused by the adsorbent structure; an indication of fluid turbulence; a measure of adsorption uniformity; a measure of shear; and/or a residence time distribution. Other fitness objectives may include, heat transfer, temperature gradients, temperature homogeneity.

### Genes

The ED module 204 describes an adsorbent structure design in terms of a set of one or more genes. A set of genes is a set of numerical parameters that describe shape characteristics of the adsorbent structure design. Each gene has a specific role in defining one or more geometric parameters of the adsorbent structure. For example, a gene can refer to the size, location, distance, or orientation of a geometric parameter. A gene can affect either a single or multiple geometric features. A geometric parameter, on the other hand, can be a product of a single gene or multiple genes working together. Having many-to-many mapping between genes and geometric parameters allows for a rich combination that can lead to a large variation in shapes for an adsorbent structure.

Each gene is associated with a value or a value range. In one embodiment, each gene has a value within the range of [0.0, 1.0]. This value is mapped to a specific geometric parameter, which falls within a certain predefined range, for example an angle within the range of [−90, 90] degrees.

By defining the geometric feature associated with the gene, and the predefined range or value associated with the gene, the sensitivity to the value change in the gene can be set. In one embodiment, the gene values can be real number, integer number and Boolean values. The following table shows the mapping from gene to geometric parameter as the function of parameter type.

| Type of geometric | Gene (real | Geometric | |
|---|---|---|---|
| parameter | number) | parameter | Mapping |
| Real number | [0.0, 1.0] | [Xmin, Xmax] | Linear |
| Integer | [0.0, 1.0] | [Imin, Imax] | Stepwise |
| Boolean | [0.0, 1.0] | [False, True] | Stepwise |

### Generator Algorithm

The generator module 206 comprises a shape generator 210 and a grid generator 212. The shape generator (SG) 210 receives a set of genes 216 from the ED module 204 and expresses the genes 216 into a candidate adsorbent structure design, such as by executing the production rule based on the design parameters as described above.

The generator module 206 outputs the adsorbent structure geometry to the CFD module 208 so that the CFD module can determine how well the geometry performs in a certain fluid mixing scenario and summarised as its performance index.

### Shape Generator Module

The role of the shape generator (SG) module 210 is to take a set of genes from ED module 204 as the shape parameters and construct an adsorbent structure surface grid 220 based on the set of genes.

It is desirable that the design system 200 is computationally robust and able to complete its task without error, despite dealing with very complex and sometimes unpredictable shapes. This requires a strategy that goes beyond the design of SG module 210 alone. The design of the SG module 210 is considered together with other components in the downstream of the design system 200.

In one embodiment, the SG module 210 defines the surface grid 220 in terms of a Cartesian grid. In one embodiment, the SG module 210 defines the surface grid 220 in terms of a set of triangles. The smallest unit in the surface grid is a voxel, which is a regular cube that can be either defined as a solid cube or a fluid cube.

In another embodiment, the SG module 210 defines the surface grid 220 in terms of a body-fitted grids such as unstructured tetrahedral grid. In some embodiments, a body-fitted grid may requires extra care to avoid cells that are too small or have large aspect ratio, because this may adversely affect the performance of the entire CFD simulation.

Mapping Genes into Shapes

The SG module 210 is configured to map the genes 216, that define a candidate adsorbent structure design determined by the ED module 204, into a surface grid 220 that represents the candidate adsorbent structure design.

The number of possible candidate adsorbent structure designs is the permutation of all possible values of the genes, so, in some embodiments, it is desirable to keep the number of genes low. Having a small number of genes does not necessarily mean that the SG module 210 cannot make complex shapes. The genes can be used recursively to achieve a high degree of complexity. It is worth noting, that forcing the number of genes to be too low may restrict the variety of candidate adsorbent structure designs produced by the ED module 204 and, therefore may reduce the chance of identifying a high performing mixer.

### Grid Generator Module

The generator module 206 further comprises a grid generator (GG) module 212. The GG module is configured to, for each of the candidate adsorbent structure designs determined by the ED algorithm 204, generate a volume grid 222 from the surface grid 220 output by the SG module 210. The CFD module 208 uses the volume grid 222 to perform a performance evaluation of a candidate adsorbent structure design.

In one embodiment, the SG module 210 communicates the surface grid 220 to GG module 212 via a solid surface described in a format known as stereolithographic (.STL) file. A .STL file is a common format in computer aided design (CAD) and three dimensional (3D) printing. In one embodiment, the surface grid 220 describes a set of triangles forming a solid surface of an adsorbent structure design.

Advantageously, the GG module 212 can accept a surface grid 220 that is not fully or accurately defined in terms of all aspects of the design. For example, the GG module 212 permits overlapping and intersecting solid bodies within the surface grid 220, or even a solid that is not perfectly water tight.

This tolerance of the GG module 212 can significantly reduce the computational burden in operating the SG module 210, because the SG module does not have to compute a high quality surface. In one embodiment, the output of the SG module 210 may comprise a description of a complex configuration of freely intersecting simple shapes.

### Resolution Approximation

The GG module produces a volume grid 222 that approximates the shape of a candidate adsorbent structure design 440 determined by the ED module 204. Although the volume grid 222 may be only an approximation of the shape of a candidate adsorbent structure design 440 determined by the ED module 204, in many situations, the approximation of the design is within the resolution range of a 3D printer technology in any case.

### FIG. 3—Grid Generator Method

FIG. 3 illustrates a flowchart of a method 300 performed by the grid generator module 212, according to an embodiment. In step 302, the GG module 212 reads, as an input, the design parameter file 214. In step 302, the GG module reads, as an input, the surface grid file 220.

In step 306, the GG module generates a Cartesian grid, given the computational domain and grid resolution. In step 308, the GG module identifies voxels intersecting solid surface. This is a fast geometric query that determines whether a voxel intersects any triangle. In some embodiments, the actual computation of intersection is not required. In some embodiments, for efficiency, the GG module is configured to perform filtering out of cases where such intersection is clearly not possible.

In step 310, the GG module 212 identifies fluid voxels. The GG module determines a point in the domain that is known to be within fluid, and given that point, the GG module sets the voxel that contains that point, as well as all connected non-intersected voxels as fluid voxels.

In step 312, the GG module 212 identifies the rest of the voxels as solid, including the intersected voxels. In step 314, the GG module 212 flags voxels that are outside the mixing tube.

In step 316, the GG module 212 identifies the fluid-solid interface grid and, in step 318, outputs the fluid-solid grid as a volume grid 222. The volume grid 222 may be described as a .STL file. The volume grid 222 may be used by the CFD module 208 to evaluate the performance of the adsorbent structure design defined by the volume grid 222. In some embodiments, the volume grid 222 is used by a 3D printer to define an adsorbent structure design.

Advantageously, the GG module 212 is able to produce a volume grid even when the inputted surface grid contains gaps, overlapping triangles, has non-consistent orientation, protrudes outside the computational domain or has incomplete parts. The tolerance of the GG module 212 reduces the level of robustness needed for the SG module 210.

### Computational Fluid Dynamics Module

The CFD module 208 performs computational fluid dynamics calculations in accordance with one or more computational fluid dynamics algorithms, wherein the computational fluid dynamics algorithms use modelling, numerical analysis, data structures to analyse and solve calculations pertaining to the flow of fluid. Computational fluid dynamics algorithms may comprise modelling techniques including finite difference, finite element, finite volume and/or smoothed particle hydrodynamics, or any combination thereof.

Determining the flow of fluid through the contactor may involve solving the Navier-Stokes equations (or equivalent) through the given geometrical domain. The Navier-Stokes equations are complex partial differential equations which in general are non-linear. In certain regimes they can be simplified and to do this one needs to know what flow regime the fluid flow through the contactor resembles. Two important fluid dynamical quantities (dimensionless numbers) are relevant in this context. They are the Reynolds number and the Mach Number [Faber 1995].

Firstly, the Reynolds number (which denotes the regime, i.e. laminar, turbulent etc.) is Re=r*L*v/m=L*v/n, where r is fluid density, L is a typical pore diameter through which the fluid flows, v a typical speed of the fluid and m the fluid's dynamic viscosity. Dynamic viscosity can also be written in terms of kinematic viscosity n as n=m/r. Typically for Reynolds number less than 1000 the flow is in the laminar regime (smooth streamlines which generally follow the shape of the geometry). Turbulence only begins above Reynolds numbers of 2300. In the range of approximately 1000 to 2300 there is so-called transitional flows (between laminar and turbulent). Typically, laminar flow problems can be solved with a linearized version of the Navier-Stokes equations.

For air at around 25 C the kinematic viscosity is approximately 1.5×10⁻⁵ m²/s up to 10⁻⁴ m²/s at close to 1000 C. The typical fluid velocity is 5 m/s and channel width around 1 mm. Using these numbers at 25 C one gets Re~333.3. This means the problem is not turbulent but rather laminar. At higher temperatures the Reynolds number decreases to around 50 (in the laminar regime).

More accurate approximations of the typical channel dimensions can vary from around 1 mm to 0.25 mm to 0.025 mm. At 25 C the Reynolds number is Re~8.33 up to 333.3 (laminar).

To obtain another estimate of Reynolds number the method may estimate a typical geometry that will have the number of Cells Per Square Inch (CPSI) which may vary from 100 to 1200. This means 10*10 to 35*35 CPSI or roughly each cell has size 25.4 mm/10=2.54 mm to 25.4 mm/35-0.726 mm. The Reynolds number (at 25 C) ranges from Re=2.54e-3*5/1.55e-5=8.19e2=819 to 0.726e-3*5/1.55e-5=2.34e2=234. Note that as far as increasing adsorption one can maximize contactor surface area which implies smaller cell sizes is better than larger cell sizes.

The Re range is roughly 47 to 820 at 25 C. If going to higher temperatures the Re decreases down to 10-100 (at 1000 C). These numbers indicate a laminar regime for this flow.

The second relevant number for this fluid is the Mach number which essentially indicates whether the fluid flow is incompressible or not. If the Mach number is much less than unity (1) then the fluid can be considered incompressible. This is important for computational modelling of the flow as an incompressible flow is generally easier to solve. The Mach number is defined as Ma=v/cs where cs is the speed of sound in the fluid. For air at 25 C the sound speed is 343 m/s while it increases up to 695 m/s at 1000 C. For our problem the Mach number at 25 C is 0.014 decreasing to 0.007 at 1000 C. So the present problem can be considered incompressible.

It is noted that the CFD modelling is macroscopic while adsorption of CO₂ at the contactor substrate is a microscopic (chemical) process. The role of CFD is to design the optimal contact geometry to bring maximum amounts of fluid to the substrate. The CFD is modelling flow physics at the macroscopic length scale—orders of 10s of microns to centimetres.

When the fluid flows through the contactor geometry it is desirable for the flow to bring as much of the fluid to the solid substrate where adsorption occurs. In addition, the flow needs to access as much as possible different parts of the contactor (rather than focussing the fluid on regions of the substrate). In that way the reactant at the substrate does not run out. A uniform, regular flow with the smallest possible pressure gradient is also desirable, i.e., no major blockages to the flow path.

These are the primary constraints that the disclosed CFD modelling adheres to, and the geometry design is based on optimizing these quantities.

To model the flow through the contactor it is possible to determine the flow field (solve the Navier-Stokes equation or equivalent model). Once the flow (velocity) field is at hand, the method may set of (fictitious) massless tracer particles from the inlet in the flow and determine their path through the contactor. If a tracer particle reaches the solid substrate, that is recorded as a (virtual) contact and then let that particle bounce of the substrate and continue its trajectory through the contactor to the outlet. At the outlet, the method measures the cross-sectional position with respect to its initial (inlet) position. In general, if there is randomization of these positions, it is quite certain the tracer particle has taken a topologically complex route (i.e. chaotic flow) through the contactor. Lastly, the method can also measure pressure gradient, for a given flow rate, through the contactor. So, there are three main quantitative measures to optimize:
(1) It is desirable to achieve mixing (or randomization) of tracers in the passage down the contactor between their initial (inlet) position to their exit (outlet) position. That is, it is desirable to generate chaotic trajectories.
(2) Number of contacts the tracer has with the contactor.
(3) Pressure gradient.

In some embodiments, the method optimizes the first two measures. The third measure may be related to the first measure. If it is necessary, the method can include the third measure in the optimization routine, but this comes at considerable extra computational cost.

In one embodiment, the CFD module 208 applies the Lattice Boltzmann method to evaluate the performance of a candidate adsorbent structure design. The Lattice Boltzmann method is a numerical fluid dynamical method that solves the Boltzmann Transport equation. The Boltzmann Transport equation describes the statistical behaviour of a thermodynamic system and its approach to equilibrium.

It can be shown, via a Chapman-Enskog expansion the solution of this equation is equivalent to the solution of the famous Navier-Stokes equations (Faber 1995) for fluid flow.

The Lattice Boltzmann method is a rapid, easily parallelized numerical method which calculates the velocity field of fluid in complicated geometries and can be comparable with experimental observations.

An input into the CFD module 208 is a volume grid 222. In one embodiment, the volume grid 222 is defined by a stereolithographic (STL) file. STL files are discretised on a Cartesian lattice. Each lattice point can either be occupied by solid material or a void (which is then available for fluid flow). In one embodiment, since the Lattice Boltzmann method also operates on a Cartesian lattice, the Lattice Boltzmann method may be readily applied, by the CFD module, to the volume grid (222).

Advantageously, complicated boundary geometries can be easily simulated with the Lattice Boltzmann method. In other CFD techniques, treating the solid boundaries appropriately can lead to extreme complications and inaccurate results, due to inability of the technique to adequately model the boundary conditions.

The central quantity in the Boltzmann transport equation, from which the Lattice Boltzmann method is derived, is the particle distribution function, f(r,u,t), which denotes the distribution of particles at position r, travelling with velocity u at time t. In the Lattice Boltzmann method, this distribution function may be discretised on a regular lattice so that particle positions are restricted to the lattice vertices (or nodes) with discrete velocity directions, eᵢ. Generally, Lattice Boltzmann models can be classified as DmQn where m denotes the number of dimensions of space and n the number of velocity directions. Common examples in 1, 2 and 3 dimensions are D1Q3, D2Q9 and D3Q19 and the discretised distribution function is denoted fi (r,t) where i=1, . . . n. The set of n vectors for each Lattice Boltzmann model are provided in (Kruger et al, 2017).

The time evolution of these distribution functions satisfies

$${f}_{i} ( r + {e}_{i} Δ t , t + Δ t ) - {f}_{i} ( r , t ) = - \frac{1}{τ} [ {f}_{i} ( r , t ) - {f}_{i}^{e q} ( r , t ) ] . \qquad ( 1 )$$

The term

$${f}_{i}^{eq}$$

is the equilibrium Maxwell distribution (written in terms of equilibrium velocities) is given by

$${{f}_{i}}^{e q} = {w}_{i} ρ [ 1 + \frac{{e}_{i} \cdot {u}^{e q}}{{c}_{s}^{2}} + \frac{{( {e}_{i} \cdot {u}^{e q} )}^{2}}{2 {c}_{s}^{4}} - \frac{{u}^{e q} \cdot {u}^{e q}}{2 {c}_{s}^{2}} ] , \qquad ( 2 )$$

where ρ is the density and wᵢ are weights which are defined for the given D3Q19 model (Kruger et al, 2017).

In Equation (2), the black dots between vectors represent a dot product operation. In Equation (1), r represents a relaxation time and it can be shown to be related to kinematic viscosity via

$$υ = {c}_{s}^{2} ( τ - 1 / 2 )$$

where cₛ is the sound speed and

$${c}_{s}^{2}$$

equals ⅓. The pressure, P, in this model is given by the equation of state

$$P = {c}_{s}^{2} ρ .$$

The LB equation (1) is single relaxation time (SRT) scheme, because only one relaxation time is involved.

The relationship to macroscopic parameters such as density and velocity are given by

ρ=Σᵢfᵢ and ρu=Σᵢfeᵢ. (3)

Once the CFD module 208 determines the velocity field, the CFD module can determine important quantities such as the amount of adsorption that occurs in the reactor and the amount of fluid mixing that occurs. The flow regime for these reactors is governed by the dimensions (size of gaps) in which fluid flow and also the maximum pressure a pump may deliver, before breakdown of the pump.

Based on these two criteria, the CFD module can determine that the flow is certainly not turbulent.

In one embodiment, to determine the two measures of substrate transport and fluid mixing, the CFD module 208 allows fictitious, massless (tracer) particles to flow in the LB calculated velocity field. The trajectory of these massless particles is followed using a simple equation for advancement of a particle according to the local velocity field, i.e.

$$\frac{dr ( t )}{dt} = u ( r ) \qquad ( 4 )$$

Equation (4) is discretised both with respect to time and space and solved with a fourth order Runga-Kutta scheme (Press et al, 2996). From Equation (4), the CFD module 208 can determine how many particles end up on the substrate and how the particles mix through the reactor. The two fitness values corresponding to the fitness objectives substrate transport and fluid mixing, are normalized to vary between zero (0) and one hundred (100). A value of zero corresponds to an extremely poor measure while a value of 100 corresponds to the best possible value of the measure. This shows clearly that the numerical methods disclosed herein can simulate a wide range of complex geometries. This is in contrast to analytical methods which provide a closed form solution to a flow problem. Such a closed form solution may be a single or multiple equations that can be rearranged to solve for the parameter in question. In such an analytical model, it is possible to explicitly calculate the optimal parameters for flow vs surface area. For example, a tube filled with particles of a given size can be modelled with an analytical model, which enables the explicit calculation of an optimal value for the length to diameter ratio of the tube. However, such analytical models are only available for simple structures, such as tubes. For more complex structures, and in particular for structures with baffles of complex geometries, it is impossible to use an analytical model. Therefore, this disclosure provides a numerical method that does not explicitly calculate on optimum but iteratively optimises the parameters towards an improved solution. This way, complicated structures comprising a large number of regular or irregularly arranged baffles can be analysed accurately.

In one embodiment, the CFD module 208 is configured to perform numerical modelling approaches such as multiphysics methods to resolve additional fitness values, such as electric fields.

### Iterative Evolutionary Improvement

The ED algorithm, performed by the ED module 204, and the CFD algorithm, performed by the CFD module 208, are coupled via the control module 202, such that the fitness values measured by the CFD module are passed to the ED module to allow the ED module to determine the next generation of candidate adsorbent structure designs.

In one embodiment, the evolutionary design module 204 evolves an initial population of one or more parent designs over a plurality of generations to determine one or more improved candidate adsorbent structure designs, wherein improvement is determined based on the fitness values for the individual candidate adsorbent structure designs, as determined by the CFD module 208.

The initial population of parent designs comprise of K individuals, wherein K comprises one or more, who are then all evaluated by the CFD module 208 with regard to the fitness objectives. In one embodiment, the fitness objectives comprise an indication of substrate transport and fluid mixing. The CFD module 208 provides fitness values, for the fitness objectives, for the initial population of parent designs. The fitness values for the K initial parent designs are transferred to the ED module 204 which carries out an analysis on these parent designs and from them predicts a set of new individual (or children) designs. The set of children designs may comprise N candidate adsorbent structure designs. K can be any number equal to or greater than 1. N can be any number equal to or greater than 1. In one embodiment, N is 16. In one embodiment K is equal to N.

This process is iterated, the performance of the N children adsorbent structure designs are determined by the CFD module 208 which evaluates their fitness with respect to the fitness objectives, and communicates the fitness values back to ED module 204. In this way the design system 200 iteratively evolve an adsorbent structure design that performs well with regard to fitness objectives, with the constraints of the design parameters.

In some embodiments, the design system 200 is configured to compare the fitness values determined by the CFD module 208 for one generation of candidate adsorbent structure designs with the fitness values determined by the CFD module 208 for a subsequent generation of candidate adsorbent structure designs, to determine an indication of a rate of change of the fitness values. Accordingly, the progress of the fitness function over generations can be tracked and when this function slows, the system has evolved to a preferred solution for this family. On average this takes the 50-100 generations.

In one embodiment, the control module 202 is configured to generate a design description of the candidate adsorbent structure design. The design description may comprise a .STL file. In one embodiment, the control module 202 is configured to control an additive printing machine, in accordance with the design description, to manufacture an adsorbent structure.

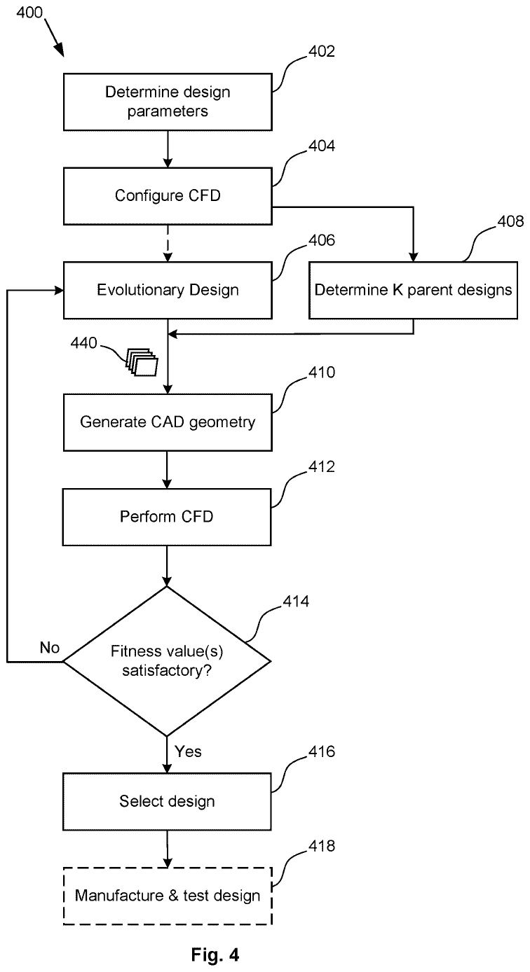

### FIG. 4—Method Flow Chart

FIG. 4 is a flowchart illustrating a 400 performed by the design system 200, which is controlled by the control module 202, according to an embodiment.

In step 402, the control module 202 determines the design parameters. Design parameters may comprise the physical dimensions of the adsorbent structure to be designed, such as a length and a diameter. The design parameters may further comprise a 3D print resolution (e.g. grain size), and other physical parameters of the desired adsorbent structure.

In step 404, the control algorithm 202 configures the CFD algorithm 208 so that it will be able to calculate appropriate fitness objectives for the specific application. The fitness objectives may be selected by the control algorithm 202 in light of the intended application or applications for the adsorbent structure being designed.

In one embodiment, method 400 may comprise developing one or more initial parent designs. The initial parent designs may be referred to as one or more first candidate adsorbent structures. From the initial parent designs the evolutionary design algorithm 204 can generate subsequent generations of candidate adsorbent structure designs.

In one embodiment, the genes for the one or more initial parent designs are determined by the ED module 204 in step 406. In such an embodiment, the method 400 may proceed from step 404 to step 406, bypassing step 408.

In one embodiment, the genes 218 for the one or more initial parent designs are determined by humans, based on an informed understanding of the underlying process, physics, and chemistry of adsorbent structures for one or more intended applications.

Accordingly, in step 408, the control algorithm 202 receives information indicative of initial adsorbent structure designs. These designs are referred to as parent designs. In one embodiment, the control algorithm 202 receives K parent designs. In one embodiment, K equals 16.

Each of the K parent designs are each described by a set of genes 218. A set of genes is a set of numerical parameters that refer to shape characteristics of the adsorbent structure design. During the process 400, the control algorithm 202 determines at least one set of genes 218, wherein the set of genes defines an adsorbent structure design that performs in terms of the fitness objectives defined by the control algorithm 202.

In step 410, the generator module 206 generates the CAD geometry for each of the adsorbent structure designs determined in step 406 or 408.

The CAD geometry for each candidate adsorbent structure design can be defined in any suitable CAD format. In one embodiment, the CAD geometry is defined in a stereolithography (.STL) file. In one embodiment, the generator module 206 determines a voxelised version of a CAD geometry for the candidate adsorbent structure designs, wherein the voxelised version is a format compatible with the 3D Printing resolution.

In some embodiments, the generator module 206 also performs a checking process to confirm that the CAD geometry for each candidate adsorbent structure design is a legitimate geometry, e.g., that it does not possess some flaws that would make the design unsuitable for adsorbing CO₂. For example, the generator module 206 may check to confirm that there is a flow path for the flow of fluid from one end of the adsorbent structure to the other end or that there are no topological discontinuities in the mixing element design.

In step 412, the CFD algorithm 208 performs computational fluid dynamics performance evaluation on each of the candidate adsorbent structure designs 440.

To complete the CFD processing in a shorter amount of time, the CFD module 208 may perform the CFD processing over a plurality of processors, which may operate in parallel. For example, in one embodiment, the CFD algorithm 208 each of the N candidate adsorbent structure designs 440 are passed to N separate compute processors (all on the same HPC platform) for evaluation by the CFD algorithm 208.

The CFD module 208 and/or the ED module 204 may utilise one or more of the following computing techniques, distributed computing, grid computing, cloud computing, localised co-processor or accelerator board, or computing across multiple platforms using a combination of job schedulers not on the same HPC platform.

### Determining Satisfactory Fitness Values

The control algorithm 202 receives fitness values 223, associated with the fitness objectives, from the CFD module 208 for each of the candidate adsorbent structure designs 440. The number and type of fitness objectives may vary depending upon the intended application for the adsorbent structures.

In embodiments, up to M (preferably 2) fitness objectives are evaluated to determine the performance of the new geometry of the candidate adsorbent structures for the specific application. The fitness values (corresponding to the individual fitness measures) range between 0 (poor adsorption) and 100 (excellent adsorption). It is noted that the purpose of the optimisation step is to maximise the area coated with the adsorbent material while limiting obstruction of the fluid flow. In one example, there is a Pareto front that contains the adsorbent structures that are not dominated by other structures in both the surface area and the fluid flow. That is, the disclosed method iteratively optimises for both objectives of surface area and fluid flow. The actual selection of one of the designs from the Pareto front may then be performed by a human step or by a pre-determined guidance parameter, such as the maximum surface for the minimum required fluid flow or the maximum fluid flow for a minimum require surface.

In step 314, the control module 202 considers at least one of the fitness values 223, produced by the CFD module 208, to determine whether the fitness value 223 satisfies a fitness threshold. How the control module 202 determines whether the fitness value satisfies the fitness threshold are satisfactory may differ based on the design parameters, an intended application for the adsorbent structures, available computational resources or other factors.

In one embodiment, the fitness threshold is indicative of a number of iterations of the workflow, and the control module 202 considers whether the fitness values satisfy the fitness threshold by comparing a number of iterations of the workflow performed by the control module 202 to the fitness threshold.

In one embodiment, the fitness threshold is indicative of a level of fitness for at least one fitness objective, and the control module 202 considers whether the fitness values satisfy the fitness threshold by comparing at least one fitness value to the fitness threshold.

In one embodiment, the fitness threshold is indicative of a change in fitness values from one generation to the next generation for at least one fitness objective, and the control module 202 considers whether the fitness values satisfy the fitness threshold by comparing the change in fitness values from one generation to the next generation to the fitness threshold.

In one embodiment, the control module 202 compares the fitness values from the N candidate designs 440 with the fitness values of the previous Q (usually 5-10) generations of candidate adsorbent structure designs.

In one embodiment, the control module 202 determines whether the termination condition is met. In one example, the termination condition comprises a condition on the fitness values, measured by the CFD module 210, such as whether the fitness values have plateaued or are sufficiently plateauing. In other words, the control module 202 calculates the change in fitness values between iterations and if the change is less than a threshold, the termination condition is met. For example, the fitness threshold may be indicative of the fitness values not increasing significantly (i.e. less than 0.001) from one generation of candidate designs 440 to the next generation of candidate designs. In one embodiment, the control module 202 considers whether the fitness values satisfy the fitness threshold by evaluating the increase in fitness values and comparing it to a threshold criterion.

### Continuing the Loop

If the control module 202 determines that the termination condition has not been satisfied, the control module may control the ED module 204 to design another generation of one or more candidate adsorbent structure designs, in step 306. In one embodiment, the control module controls the ED module 204 to perform another iteration of step 306, to determine one or more second candidate adsorbent structure designs based on the one or more first candidate adsorbent structure designs. The ED module may determine the one or more second candidate adsorbent structure designs based on the one or more first candidate adsorbent structure designs and based on fitness values, determined by the CFD module 208, associated with the one or more first candidate adsorbent structure designs.

The control module 202 may control the CFD module 208 to evaluate the performance of the candidate designs produced by the ED module 204.

In one embodiment, the set of fitness values for each of the N candidate adsorbent structure designs 440 is passed to the control module 202, and then to the ED module 204, via 228, to guide the ED module's generation 306 of the next generation of candidate adsorbent structure designs.

### Exiting the Loop

If the control module 202 determines that the termination condition has been satisfied, the control module stops the iterative design/test loop and proceeds to step 416. In step 416, the control module 202 selects an adsorbent structure design from the set of candidate adsorbent structure designs evaluated by the CFD module 208.

In one embodiment, the control module 202 selects an adsorbent structure design based on the Pareto front of a graph of the fitness values for the set of candidate adsorbent structure designs. In one embodiment, preferred designs selected are those that are closest to the intersection of the Pareto front and the central diagonal of fitness objectives for two independent fitness values.

In one embodiment, the control module 202 selects more than one of the candidate adsorbent structure designs.

In response to selecting a candidate adsorbent structure design in step 316, the control module may output a digital representation of the adsorbent structure design selected in step 416. The digital representation may comprise a stereolithographic file (.STL).

In optional step 418, the digital representation be transferred to a manufacturing system to manufacture the adsorbent structure. The manufacturing system may comprise a 3D printer for processing and printing. The manufacturing system may utilise manufacturing techniques comprising printing directly from catalytic metals (e.g. solid platinum), coatings, gradient coatings, decorated coatings (e.g. covering in nanoparticles) and/or selectively patterned coatings, or any combination thereof.

In some embodiments, the 3D printer is configured to advise if the given adsorbent structure geometry is unsuitable for printing. In some embodiments, the 3D printer outputs a solid metal 3D printed adsorbent structure. The printed adsorbent structure can be transferred to a workshop and fitted with inlets and outlets and undergo experimental validation.

In some embodiments, the manufacturing system comprises a system to generate a casting a core for use in a foundry, the use of emerging additive/subtractive machining equipment, or standard production techniques such as multi-axis CNC technology which could also fabricate mixers with larger feature sizes than state-of-the-art 3d metal printing. In one embodiment, the manufacturing system is configured to metallise a conductive polymer mixer and dissolve the superstructure to leave a delicate metallic mixing element.

Steps of method 300 may be performed on one or more processing devices (e.g. processors, servers, computers, application specific integrated devices, field-programmable gate arrays, or other device configured to perform calculations in accordance with machine-readable instructions). For example, the ED module 204 may execute on a first processing device and the CFD module 208 may execute on a second processing device. Alternatively, the ED module and the CFD module may execute on the same processing device.

### L-System Approach

As set out above, in step 406 of method 400, SG module 210 generates a candidate adsorbent structure design based on the design parameters provided by the ED module 204. In particular, SG module 210 generates the candidate adsorbent structure design by executing a production rule. The production rule is parameterised by the design parameters, that is, by the genes generated by ED module 204. More generally, the production rule is a predefined process that defines how the candidate adsorbent structure design is generated. In that sense, the production rule may also be referred to a as a generator function.

During the process of determining new design parameters by the ED module 204, the production rule remains unchanged and only the parameter values are updated to generate new candidate adsorbent structure designs. In one embodiment, the production rule is represented by a text string, which adheres to a predefined schema, syntax and/or grammar. For example, the schema, syntax and/or grammar may provide for a command set. The production rule, represented by the text string may therefore comprise a selection of the commands from the command set. The underlying concept of the production rule may be a virtual writing head and the commands define movements of the writing head. This way, the commands or a combination of commands define geometric properties of the candidate adsorbent structure design.

The above described commands can define geometric properties of an individual component of the candidate adsorbent structure designs, which may also be referred to as a template shape component or baffle template because the template shape component redirects the flow of fluid. The baffle template can have any shape that redirects the flow of liquid, such as planar shapes, including plates and vanes, as well as three-dimensional shapes including rods and cylinders and other shapes. The geometric properties, e.g., shape, of the baffle template can be adjusted by changing the design parameters in the product rule. The command set may then also comprise commands to replicate the baffle template to generate multiple baffles. This way, execution of the production rule including those replication commands generates a plurality of baffles. Each baffle protrudes into the fluid flow to thereby divert the flow of fluid and cause mixing. More specifically, when considering a tubular arrangement to guide the fluid flow, the adsorbent structure including the baffles make up the inside of the adsorber system. That is, the production rule that defines the repetition of the template baffle, as parameterised by the design parameters, causes the generation of multiple baffles within the fluid flow or within the tubular fluid guide. The baffles deviate the fluid flow and therefore aid adsorption from the fluid. Due to the parameterisation of the production rule, a wide range of baffle structures can be created within the tubular fluid guide.

In one embodiment, the shape of the candidate adsorbent structure designs is based on Lindenmeyer (or L) systems, and three different L-system families were trialled to produce optimal geometries. These three families either have square cross-section tubules or hexagonal cross-section tubules with the adsorbent structure, including multiple parameterised baffles, located within the tubules. The best performing results came from the hexagonal cross-section tubules. The output of the computational workflow are Stereo-Lithographic (or STL) files which are a particular CAD format that is suitable for 3D Printing. The best performing designs have been sent to the 3D Printing Lab.

L-Systems, or Lindenmayer systems, were developed by Aristid Lindenmayer in the 1960s (as described in Prusinkiewicz et al, 1990) as a way of generating geometric structures. They are essentially a formal grammar, whose production rules equate to the motion of a “write head”, which are used to create a structure.

An L-System consists of an alphabet of symbols that are used to make strings. Each element of the string is either an instruction (i.e. command) to the write head (e.g. “turn left”, or “draw one unit”), or the head of another production rule that is expanded into a given string. Thus, an initial “axiom” (string) can be expanded in a recursive fashion to any depth.

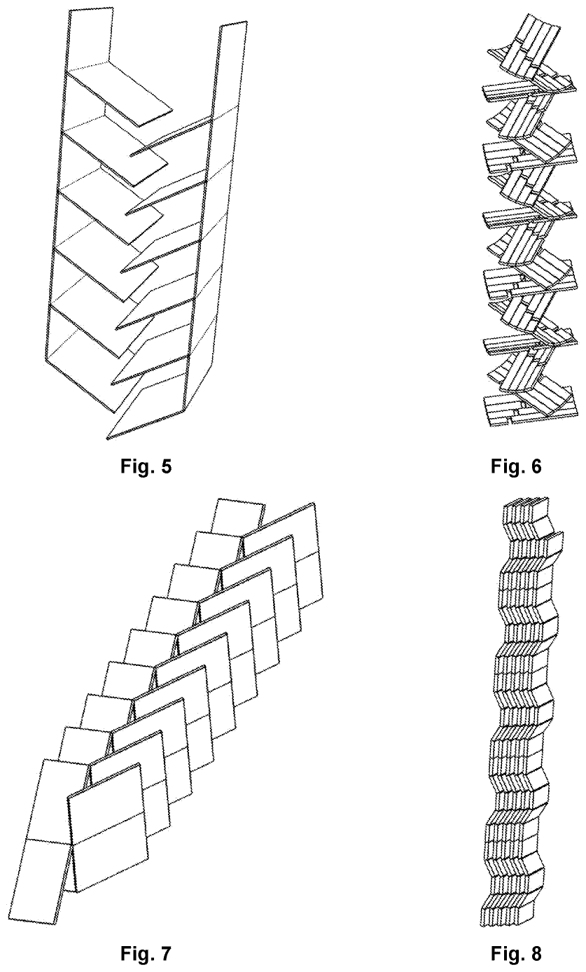

The L-Systems can be used to define families of parameterised shapes. For example, a family referred to as “bristle” is shown in FIG. 5.

This bristle design is created with the following L-System production rule:
AXIOM [A]\hat{ }(90)f(1.0)v(90)F(OFFSET)>(180) A
RULE A F(BETWEEN)[\hat{ }(SLOPE)F(WING)]A

“AXIOM” defines the starting state of the string. “A” is a production rule, and other symbols represent commands to the write head; for example, \hat{ }(angle) to turn “up” by the given angle, and > (angle) to turn “right” by the given angle. The current orientation is a system state variable. The complete specification for the “bristle” family production rule is as follows:

| #PARAM | Name | init-val | min-val | max-val | mult-sd |
|---|---|---|---|---|---|
| PARAM | SLOPE | 60 | 10 | 160 | 0.05 |
| PARAM | WING | 0.6 | 0.1 | 1.5 | 0.05 |
| PARAM | OFFSET | 0.2 | 0.0 | 0.4 | 0.05 |
| PARAM | BETWEEN | 0.4 | 0.1 | 1.0 | 0.05 |
| PARAM | DEPTH | 6 | 4 | 10 | 0.2 |

AXIOM [A] \hat{ }(90) f(1.0) v(90) F(OFFSET) >(180) A
RULE A F(BETWEEN) [\hat{ }(SLOPE) F(WING)] A
DEPTH 4
WIDTH 1
HEIGHT 0.01
ANGLE 60

Here, several “arguments” to the write command have been replaced with parameters. For example, the argument to “F” (draw forward) controls how far to draw. Rather than a fixed length, there is the parameter “OFFSET”. The ED module can explore values of OFFSET (between minimum and maximum sensible values) during the design phase. Further parameters include BETWEEN, SLOPE, and WING. The disclosed evolutionary design approach, the space of valid assignments to these parameters is explored using a Genetic Algorithms, as described herein. Again, this enables the exploration of a vast design space that spans a range of significantly different candidate adsorbent structure designs, which not only differ in their dimensions but also substantially in shape and other geometric features of their individual components, i.e. baffles protruding into the fluid flow inside the tubules.

In other words, parameters of the Bristle candidate adsorbent structure designs are varied by the ED module 204 to iteratively optimise the fitness value. That is, the genes in the genetic algorithm map to the parameters of the Bristle production rule.

One major difference between families is the shape of the enclosing vessel. While circular vessels offer some advantages in terms of stability when being evacuated, square and hexagonal shapes pack together much more efficiently. We therefore explored only square and hexagonal vessels.

### HexRain

The Hexrain family has a hexagonal wall structure, and is based loosely on the concept of rain stick, used to make the sound of rain as grains fall through. An example of the Hexrain family is given in FIG. 6. The shape is enclosed in a hexagonal wall, not shown so that more detail can be seen. Fourteen parameters control the shape, including the size of each hole within each “baffle”, the angle each baffle makes to the previous one, and the distance between baffles.

The complete specification of the hexrain family production rule is given below:

| | | init- | min- | max- | mult- |
|---|---|---|---|---|---|
| #PARAM | Name | val | val | val | sd |
| PARAM | BTWN | 0.3 | 0.1 | 1.0 | 0.05 |
| PARAM | PITCH-1 | 10 | −30 | 30 | 0.1 |
| PARAM | PITCH-2 | 10 | −30 | 30 | 0.1 |
| PARAM | PITCH-3 | 10 | −30 | 30 | 0.1 |
| PARAM | DEPTH | 20 | 10 | 50 | 0.2 |
| PARAM | WID | 0.1 | 0.05 | 0.2 | 0.01 |
| PARAM | BENCH_L1 | 0.2 | 0.1 | 0.9 | 0.01 |
| PARAM | BENCH_R1 | 0.75 | 0.1 | 0.9 | 0.01 |
| PARAM | BENCH_L2 | 0.3 | 0.1 | 0.9 | 0.01 |
| PARAM | BENCH_R2 | 0.65 | 0.1 | 0.9 | 0.01 |
| PARAM | BENCH_L3 | 0.4 | 0.1 | 0.9 | 0.01 |
| PARAM | BENCH_R3 | 0.55 | 0.1 | 0.9 | 0.01 |
| PARAM | BENCH_L4 | 0.5 | 0.1 | 0.9 | 0.01 |
| PARAM | BENCH_R4 | 0.45 | 0.1 | 0.9 | 0.01 |

AXIOM ^ (90) + (30) A
# Rule A moves between blades
RULE A [B] f (WID) f (WID) −(60) | f (WID) f (WID) |
^ (90) f (BTWN)
v (90) A
# Rule B draws a whole blade
RULE B U v (PITCH-1) V v (PITCH-2) W v (PITCH-3) X
# Rules U, V, W, X draw one section of the blade in two parts
# (left and right)
RULE U [−(90) f (0.5) + (90) w (BENCH_L1) 1 (WID)] \
[ +(90) f (0.5) −(90) w (BENCH_R1) r (WID)] f (WID)
RULE V [−(90) f (0.5) +(90) w (BENCH L2) 1 (WID)] \
[ +(90) f (0.5) −(90) w (BENCH R2) r (WID)] f (WID)
RULE W [−(90) f (0.5) +(90) w (BENCH L3) 1 (WID)] \
[ +(90) f (0.5) −(90) w (BENCH R3) r (WID)] f (WID)
RULE X [−(90) f (0.5) +(90) w (BENCH L4) 1 (WID)] \
[+(90) f (0.5) −(90) w (BENCH R4) r (WID)] f (WID)
WIDTH 1
HEIGHT 0.03
ANGLE 60

The parameters of the Hexrain candidate adsorbent structure designs are varied by the ED module 204 to iteratively optimise the fitness value. That is, the genes in the genetic algorithm map to the parameters of the Hexrain production rule.

### X System

An example embodiment of L-Systems referred to as an X system is provided in FIG. 7. The X system has only 4 parameters, controlling the angles each element of a pair makes to the other, and the distance between pairs. The complete specification of the ‘x’ family production rule is provided below:

| | | init- | min- | max- | mult- |
|---|---|---|---|---|---|
| #PARAM | Name | val | val | val | sd |
| PARAM | DEPTH | 10 | 10 | 50 | 1 |
| PARAM | PITCH | 30 | 5 | 60 | 2 |
| PARAM | ROLL | −45 | −45 | 30 | 2 |
| PARAM | LEN | 0.5 | 0.25 | 1 | 0.1 |

AXIOM ^ A
# Rule A does one pair, then moves on
RULE A [B] [C]^ (90) f (1) v (90) A
# Rule B does the left blade, rule C does the right blade
RULE B^ (PITCH) < (ROLL) [r (LEN)
r (LEN)] | ] (LEN) l (LEN)]
RULE C v (PITCH) > (ROLL) [ (LEN) 1
(LEN)] | [ r (LEN) r (LEN)]
WIDTH 1
HEIGHT 0.03
ANGLE 90.

The parameters of the X-system candidate adsorbent structure designs are varied by the ED module 204 to iteratively optimise the fitness value. That is, the genes in the genetic algorithm map to the parameters of the X-system production rule.

### Ripple

An example of the ripple family is shown in FIG. 8. The ripple family has 10 parameters controlling the length of elements, and the angle of slopes. The complete specification of the ripple family production rule is given provided below:

| | | init- | min- | max- | mult- |
|---|---|---|---|---|---|
| #PARAM | Name | val | val | val | sd |
| PARAM | REP | 4 | 2 | 10 | 1 |
| PARAM | COUNT | 4 | 2 | 10 | 1 |
| PARAM | BTWN | 0.5 | 0.1 | 2 | 0.5 |
| PARAM | OFFSET | −0.1 | −0.5 | 0.5 | 0.1 |
| PARAM | LEN1 | 1 | 0.1 | 2.0 | 0.1 |
| PARAM | LEN2 | 1 | 0.1 | 2.0 | 0.1 |
| PARAM | LEN1 | 1 | 0.1 | 2.0 | 0.1 |
| PARAM | LEN3 | 1 | 0.1 | 2.0 | 0.1 |
| PARAM | LEN4 | 1 | 0.1 | 2.0 | 0.1 |
| PARAM | SLOPE | 30 | 10 | 80 | 1 |

# C is standard strip, D is the top one, that
starts a little different
AXIOM {C} (REP) D
RULE A G (LEN1) ^ (SLOPE) G (LEN2)
v (SLOPE) G (LEN3) v (SLOPE) G (LEN2)
^ (SLOPE) G (LEN4)
RULE C [A {A} (COUNT)] ^ (90)
f (BTWN) v (90) <(90) f (OFFSET)
>(90)
RULE D [B {A} (COUNT)]
RULE B f (LEN1) ^ (SLOPE) f (LEN2)
v (SLOPE) G (LEN3) v (SLOPE) G (LEN2)
^ (SLOPE) G (LEN4)
DEPTH 4
WIDTH 2
HEIGHT 0.2
ANGLE 30

The parameters of the Ripple candidate adsorbent structure designs are varied by the ED module 204 to iteratively optimise the fitness value. That is, the genes in the genetic algorithm map to the parameters of the Ripple production rule.

### Application Specific Designs

There are many applications for adsorbent structures. Differences in the design features of adsorbent structure designs may lend an adsorbent structure to be more suitable for one application than another application.

Accordingly, an adsorbent structure that performs well for one application may not perform well in another application. Similarly, an adsorbent structure that is unsuitable for one application, may be quite suitable for another application.

The evolutionary design process, and the CFD evaluation process may take into account the intended application of the adsorbent structure.

### Results.

The method described above that involves the execution of the production rule results in a vast range of different structures. One common theme with the resulting structures after the genetic optimisation is that the comprise an elongated integral scaffold in the sense that the entire scaffold can be produced using additive manufacturing techniques, such as 3D printing. This means the scaffold consists of a single piece of material as a result of the manufacturing. Of course, other manufacturing techniques can be used. The scaffold is elongated along a longitudinal axis of the adsorbent structure, which also defines the direction of flow from the inlet to the outlet.

The scaffold comprises a plurality of geometrically shaped components as defined by the production rule. For example, the scaffold comprises separated rectangles (bristle), separated baffles (hexrain), connected shapes (x-system) or ramps with connected rectangles (ripple). Each component is configured and arranged in multiple orientations along the longitudinal axis of the scaffold. That is, the orientation may change along the axis of the scaffold. For example, in the bristle configuration, a first rectangle slopes one way and then the following rectangle on the other side slopes the opposite way, which means each component is configured and arranged in multiple orientations.

Further, the components form one or more sets of components that share a common orientation or other common feature. For example, the bristle structure in FIG. 5 and the X-structure in FIG. 7 show the left vertical set and the right vertical set. More particularly, the bristle structure comprises multiple rectangular components divided into a first set and a second set. Within each set, the components are parallel and longitudinally aligned, that is, their position orthogonal to the longitudinal axis is the same for each component. Finally, the components of the first set, shown on the left of FIG. 5 are interleaved with components of the second set on the right. This means, there is a rectangle sloping down from the left side wall alternating with a rectangle sloping down from the right side wall.

The hexrain structure in FIG. 6 comprises at least four polygonal baffles arranged in multiple orientations within a given set of components and repeated along the longitudinal axis of the scaffold. A baffle here is a rectangular component or sheet that obstructs the fluid flow with openings to provide fluid communication through the baffles. The figure shows every third component shares the same rotation angle in the example of hexagonal side walls. For square side walls it would be every second baffle that is aligned. So when viewed from the top, i.e. along the longitudinal axis, the shapes of one set align with each other.

The structure in FIG. 7 comprises multiple components comprising multiple pairs. The components of one pair abut and may be connected to each other. Further, the two components of one pair are located at opposite side walls of the structure and the first components of the multiple pairs are parallel and longitudinally aligned. Similarly, the second components of the multiple pairs are also parallel and longitudinally aligned.

Finally, the ripple structure in FIG. 8 comprises sets of connected components where the figure shows five such sets. The connection here is to form a contiguous substructure of components along the longitudinal axes of the structure. In this example, the contiguous substructure is replicated transversally five times.

The sets have a polygonal cross-section, such as hexagonal or square, so that they fit into the contactor 102 as shown in FIG. 1. This way, the components define a plurality of passages configured for flow of one or more fluids through the passages. For example, the bristle structure in FIG. 5 defines a passage between each two of the rectangular components. While the fluid passes through the passages, the fluid contacts the surface of each component during flow and reaction thereof through the structure. As can be seen in the figures, each set of components forms a continuous network of passages arranged in multiple orientations relative to one another.

### Coating

In some implementations, DAC comprises an absorbent-based process that uses a metal organic framework (MOF) polymer nanocomposite as an adsorbent structure to adsorb CO₂. That is, the adsorbent structures proposed herein can be created by additive manufacturing using MOF polymer nanocomposite. MOFs can be manufactured to maximise surface area for a given volume. A large adsorbent surface area of the adsorbent structure is often desirable because the actual CO₂ content air is extremely low (around a few hundred parts per million). Materials for the MOF can be selected to preferentially adsorb CO₂. As set out above, the disclosed methods perform optimisation for the surface area as well as the fluid flow so as not to obstruct the fluid flow overly to achieve a maximum surface area.

In another example, the adsorbent structure is first manufactured by a suitable structural material and then coated with an adsorbent coating, such as zeolite powder, chitosan, or a catalytic coating.

### Effectiveness of the Genetic Algorithm

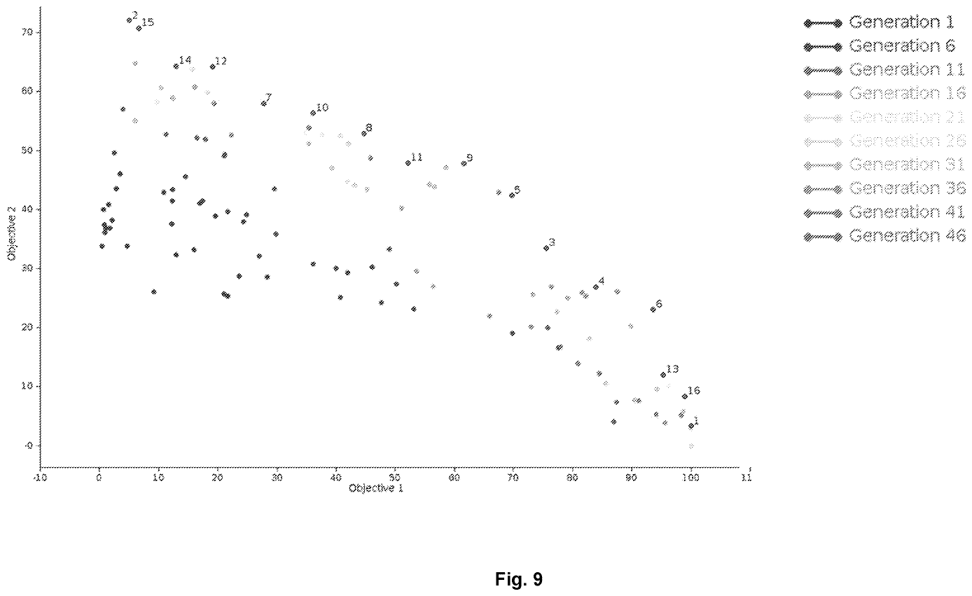

The genetic algorithm proceeds in “generations”, with each generation taking the best solutions of the previous generation and generating new solutions via cross-over and mutation. The goal is that each generation should improve the quality of the best solutions. FIG. 9 demonstrates the effectiveness of the genetic algorithm. The horizontal axis shows the first objective; the vertical axis shows the second-both on a scale of 0-100. The marks represent the objective values of solutions, and the colour shows the generation they were produce, from generation 1 in blue through yellow to generation 46 in red. As can be seen, the genetic algorithm improves solution values over time. The final Pareto front of non-dominated solutions is numbered.

### Bristle Results

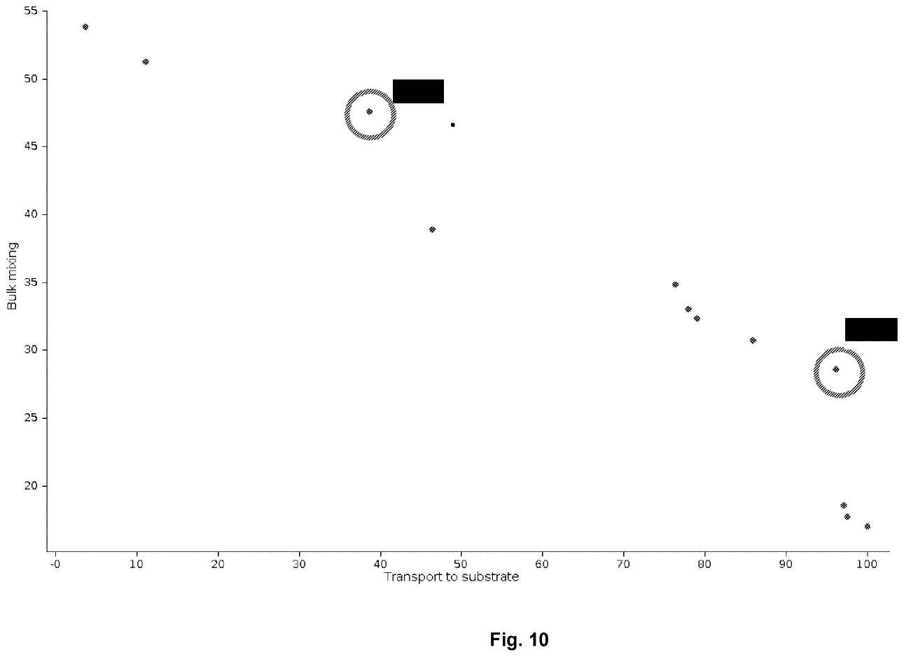

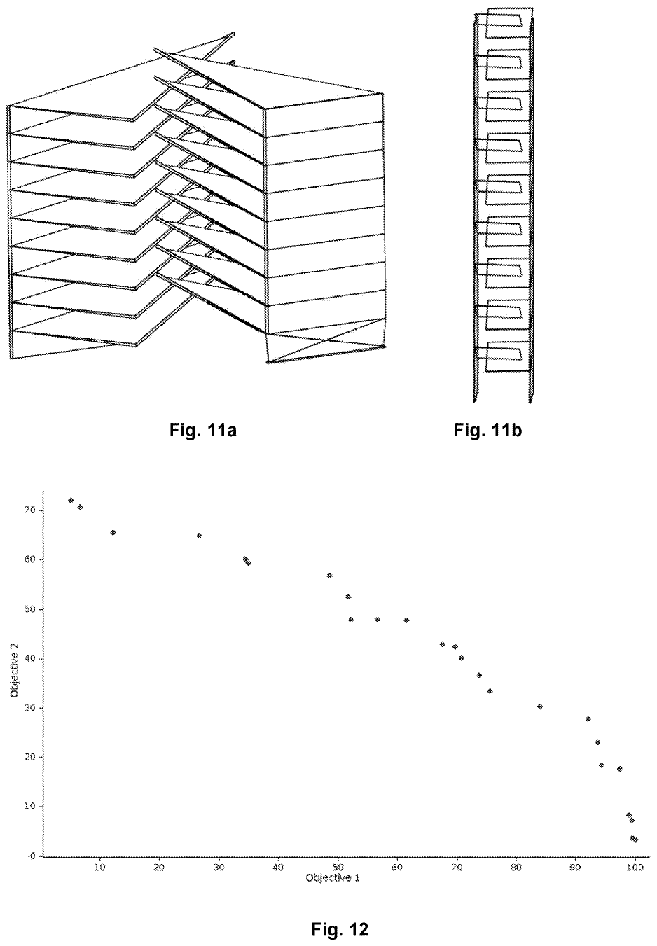

The Bristle system was tested in simulation. The family produced results that spanned the range of objective values for transportation to substructure but was only able to achieve moderate values (up to ~50) for bulk mixing. FIG. 10 shows the non-dominated (Pareto) results, and FIGS. 11a and 11b show two of the more successful designs. The term “non-dominated” means neither objective measure is dominant at the expense of the other measure.

### Hexrain Results

FIG. 12 shows a selection of solution values for the hexrain family. As can be seen, the family is able to generate individuals with a wide range of fitness on the first objective but is only able to generate solutions with more moderate values for the 2nd objective, with a maximum of around 70/100.

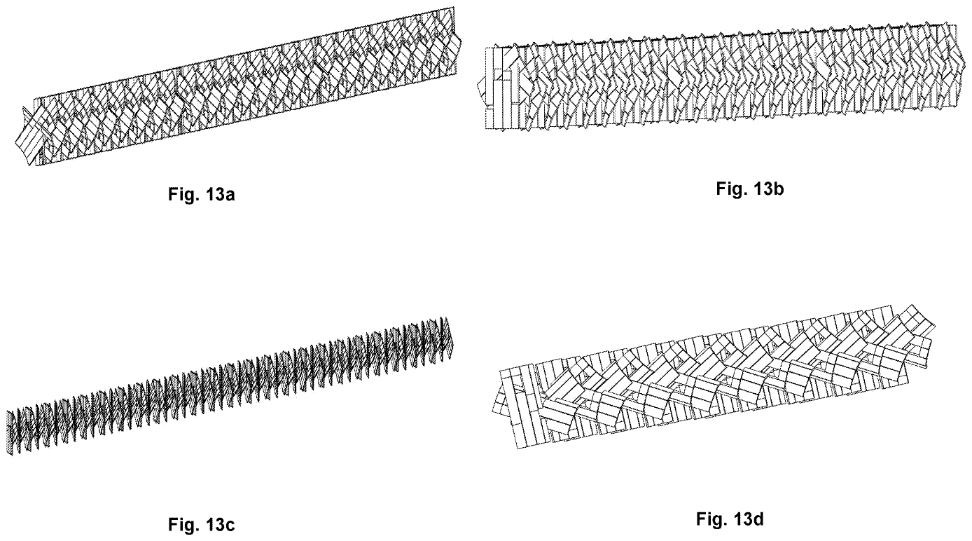

FIGS. 13a-13d illustrates examples of successful members of the “hexrain” family of geometries.

### X System

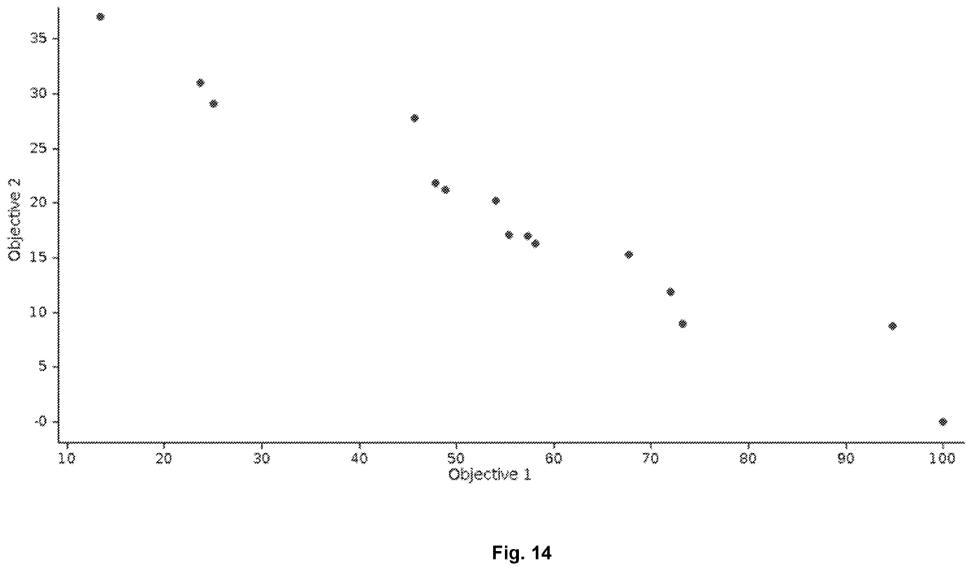

The x system did not prove to be as effective as ‘hexrain’ for the bulk mixing (y axis) fitness measure. The non-dominated solutions for the X system are presented in FIG. 14.

### Vast Design Space Explored

Using an embodiment of the design system 200, the inventors were able to explore the performance of a vast array of candidate adsorbent structure designs. The candidate adsorbent structure designs evolved and evaluated by design system 200 varied in terms of their respective base geometries. The candidate adsorbent structure designs evolved and evaluated by design system 200 also varied in terms of the number, shape, angle, arrangement, and combinations of polytope structures (e.g. projections).

It would not be feasible to explore such a vast design space through traditional experimental workflow or design experiment methods comprising the design, manufacture and testing of candidate adsorbent structure designs.

### TERMINOLOGY

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiment disclosed herein, without departing from the broad general scope of the present disclosure. The present embodiments are, therefore, to be considered in all respects as illustrative and not restrictive.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

References herein to software or executable instructions are to be understood as referring to executable instructions stored in volatile or non-volatile memory. The memory can include any data storage device that can store data which can thereafter be read by a processor. Examples of memory include read-only memory (ROM), random-access memory (RAM), magnetic tape, optical data storage device, flash storage devices, or any other suitable storage devices.

### REFERENCES

The content of the following references are incorporated herein by reference.
Cheney N, MacCurdy R, Clune J and Lipson, H (2013 July) Unshackling evolution: evolving soft robots with multiple materials and a powerful generative encoding’, In Proceedings of the 15th annual conference on Genetic and evolutionary computation, pp. 167-174. ACM.
Deb, Kalyanmoy, et al. A fast elitist non-dominated sorting genetic algorithm for multi-objective optimization: NSGA-II. International conference on parallel problem solving from nature. Springer, Berlin, Heidelberg, 2000.
Eiben AE and Smith JE (2003) Introduction to evolutionary computing, Springer, Heidelberg.
Faber M (1995) Fluid dynamics for physicists, Cambridge University Press, Cambridge.
Kruger T, Kusumaatmaja H, Kuzmin A, Shardt O, Silva G, Magnus Viggen E (2017) The Lattice Boltzmann method: Principles and practice, Springer, Switzerland.
Press WH, Teukolsky, SA, Vettering, W T and Flannery, BP (1996) Numerical recipes in Fortran90, Cambridge University Press, Cambridge.
Prusinkiewicz, Przemyslaw and Aristid Lindenmayer (1990) “The Algorithmic Beauty Of Plants” Springer-Verlag, New York, XII+228 pages

1. A method of determining an adsorbent structure design, the method comprising:
determining, one or more design parameters, the one or more design parameters parameterising a production rule;
determining, by a design algorithm executing on a first processing device, a candidate adsorbent structure design based on the one or more design parameters by executing the production rule,
wherein determining the candidate adsorbent structure design comprises generating a replication of a baffle template, as defined by the production rule parameterised by the one or more design parameters, to generate multiple repetitions of the baffle template protruding into the fluid flow;
applying a computational fluid dynamics algorithm, executing on a second processing device, to the candidate adsorbent structure design to determine a fitness value;
iteratively optimising the design parameters by repeatedly (i) determining the candidate adsorbent structure design and (ii) determining the fitness value to improve the fitness value; and
in response to the fitness value satisfying a fitness threshold, selecting the candidate adsorbent structure design to be manufactured.

2. The method of claim 1, wherein the production rule is represented by a text string.

3. The method of claim 2, wherein the text string comprises a selection of commands from a command set.

4. The method of claim 3, wherein the command set comprises commands that define movements of a writing head to define geometric properties of the candidate adsorbent structure design.

5. The method of claim 3, wherein the command set comprises one or more commands to replicate a template shape component to generate multiple repetitions of the template shape component to generate a plurality of shape components.

6. The method of claim 5, wherein the one or more commands to replicate the template shape are recursive commands.

7. The method of claim 1, further comprising:
generating a design description of the candidate adsorbent structure design; and
controlling an additive printing machine, in accordance with the design description, to manufacture an adsorbent structure.

8. (canceled)

9. The method of claim 1, wherein the fitness value comprises one or more of an indication of a level of adsorption, a bulk mixing level, or a pressure drop caused by the candidate adsorbent structure design.

10-11. (canceled)

12. The method of claim 1, wherein the design algorithm comprises an evolutionary design algorithm.

13. (canceled)

14. The method of claim 12, wherein the evolutionary design algorithm comprises a shape generator algorithm and a grid generator algorithm.

15. The method of claim 14, wherein determining a candidate adsorbent structure design comprises:
determining a set of genes defining the candidate adsorbent structure design;
determining, using the shape generator algorithm, a candidate adsorbent structure shape based on a set of genes; and
determining, using the grid generator algorithm, a candidate adsorbent structure volume based on the candidate adsorbent structure shape,
wherein determining the set of genes comprises determining the set of genes based on the design parameters.

16. (canceled)

17. The method of claim 1, wherein:
determining a candidate adsorbent structure design comprises determining a plurality of candidate adsorbent structure designs,
applying a computational fluid dynamics algorithm comprises for each candidate adsorbent structure design of the plurality of candidate adsorbent structure designs, apply a computational fluid dynamics algorithm, executing on the processing device, to the candidate adsorbent structure design to determine a respective fitness value, and
the computational fluid dynamics algorithm comprises a numerical module configured to calculate the velocity field of fluid flowing through the candidate adsorbent structure design and wherein the computational fluid dynamics algorithm applies a Lattice Boltzmann method.

18-20. (canceled)

21. The method of claim 1, wherein iteratively optimising is for objectives of surface area and fluid flow.

22-28. (canceled)

29. An elongated integral scaffold comprising:
a replication of a baffle template, as defined by a production rule parameterised by one or more design parameters, configured to generate multiple repetitions of the baffle template protruding into the fluid flow,
wherein the elongated integral scaffold further comprises a plurality of geometrically shaped components,
wherein each of the geometrically shaped components is configured and arranged in multiple orientations along the longitudinal axis of the scaffold to form one or more sets of components having a polygonal cross-section and defining a plurality of passages configured for flow of one or more fluids through the passages while contacting a surface of each component during flow and reaction thereof through the structure.

30. The elongated integral scaffold of claim 29, wherein each component is supported by an outer wall of the adsorbent structure.

31. The elongated integral scaffold of claim 29, wherein each set of components forms a continuous network of passages arranged in multiple orientations relative to one another, wherein each set of components are polytope structures repeated periodically along the longitudinal axis of the elongated scaffold.

32-33. (canceled)

34. The adsorbent structure of claim 29, wherein each set of components form a ripple structure that extends along the longitudinal axis of the scaffold.

35. The adsorbent structure of claim 29, wherein each set of components is a pair of rectangular sheets that are repeated at one or more angles along the longitudinal axis of the scaffold.

36. The adsorbent structure of claim 29, wherein each set of components comprises multiple parallel, longitudinally aligned rectangular components and the rectangular components of a first set are interleaved with rectangular components of a second set.

37. The adsorbent structure of claim 29, wherein each set of components comprises at least four polygonal baffles arranged in multiple orientations within a given set of components and repeated along the longitudinal axis of the scaffold.

38-39. (canceled)
